(19) United States
(12) Patent Application Publication
(10) Pub. No.: US 2009/0189409 A1
(43) Pub. Date: Jul. 30, 2009

(54) RISE AND SET VEHICLE SUN VISOR

(76) Inventor: CAROLYN B. PORCH, Abilene, TX (US)

Correspondence Address: James Ray & Associates, 2640 Pitcairn Road, Monroeville, PA, 15146, US

(21) Appl. No.: 12/357,639

(22) Filed: Jan. 22, 2009

Related U.S. Application Data
(60) Provisional application No. 61/023,652, filed on Jan. 25, 2008.

(51) Int. Cl. B60J 3/02

(52) U.S. Cl. 296/97.7; 296/97.9

(57) ABSTRACT

An apparatus for enabling a driver to block sun's glare entering virtually any area of a vehicle. The apparatus comprises a first member having a first predetermined size and a first predetermined shape for engagement with a predetermined interior surface adjacent one of a windshield and a side window of such vehicle for blocking a sun's rays. There is at least one second member having a second predetermined size and a second predetermined shape for engagement with one of the first member. A hook and loop fastening system is engageable with the first member and the at least one second member and such predetermined interior surface adjacent such windshield and such side window of such vehicle for securing the first member and the at least one second member to such interior surface of such vehicle.

### CROSS REFERENCE TO RELATED APPLICATIONS

This application is closely related to and claims benefit from U.S. Provisional Application Ser. No. 61/023,652 filed Jan. 25, 2008.

### FIELD OF THE INVENTION

The present invention relates, in general, to a sun visor, and, more particularly, the present invention relates to a movable three piece sun visor that enables a driver to block sunlight entering virtually any area of the car, such visor securely attaches to the headliner of the vehicle.

### BACKGROUND OF THE INVENTION

Many drivers face a challenging commute to work, school, or simply performing errands. The direct sunlight that hits the windshield or reflects from another vehicle can be blinding. This can be unusually bad when driving east in the early morning or driving west when the sun is setting. With only two visors in place in a car, many drivers must move about when driving in order to see clearly. This distraction can be dangerous. Without a better way to protect the driver from the glare of the blinding sun, such driver may become distracted and may become involved in an accident.

Thus, it would be advantageous if there were an apparatus that could assist the two visors presently available so as to give the driver a better way of protecting his vision from the sun's glare.

### SUMMARY OF THE INVENTION

In a first aspect the present invention provides an apparatus for enabling a driver to block sun's glare entering virtually any area of a vehicle. The apparatus comprises a first member having a first predetermined size and a first predetermined shape for engagement with a predetermined interior surface adjacent one of a windshield and a side window of such vehicle for blocking a sun's rays. There is at least one second member having a second predetermined size and a second predetermined shape for engagement with one of the first member. A fastening means is engageable with the first member and the at least one second member and such predetermined interior surface adjacent such windshield and such side window of such vehicle for securing the first member and the at least one second member to such interior surface of such vehicle.

In a second aspect there is provided an apparatus for enabling a driver to block sun's glare entering virtually any area of a vehicle. The apparatus comprises a first member having a first predetermined size and a first predetermined shape for engagement with a predetermined interior surface adjacent a windshield of such vehicle for blocking a sun's rays. There are two second members, each second member having a second predetermined size and a second predetermined shape for engagement with at least one of the first member and such predetermined interior surface adjacent such windshield of such vehicle for blocking such sun's rays. A fastening means is engageable with the first member and the two second members and such predetermined interior surface adjacent such windshield of such vehicle for securing at least one of the first member to an interior surface of such vehicle adjacent such windshield and for securing at least one of such two second members to one of the first member and to such interior surface of such vehicle.

In a third aspect the present invention provides an apparatus for enabling a driver to block sun's glare entering virtually any area of a vehicle. The apparatus comprises a first member having a first predetermined size and a first predetermined shape for engagement with a predetermined interior surface adjacent a windshield of such vehicle for blocking a sun's rays. There are two second members, each second member having a second predetermined size and a second predetermined shape for engagement with at least one of the first member and such predetermined interior surface adjacent such windshield of such vehicle for blocking such sun's rays. A fastening means is engageable with the first member and such two second members and such predetermined interior surface adjacent such windshield of such vehicle for securing at least one of the first member to an interior surface of such vehicle adjacent such windshield and for securing at least one of the two second members to one of such first member and to such interior surface of such vehicle.

### OBJECTS OF THE INVENTION

It is, therefore, one of the primary objects of the present invention to provide a movable sun visor that can be secured easily in a desired area.

Another object of the present invention is to provide a movable sun visor that enables the driver to block the sunlight from virtually any area.

Still another object of the present invention is to provide a movable sub visor that comes in separate pieces that can be connected by means of a hook and loop fastening system.

Yet another object of the present invention is to provide a movable sun visor that can be attached easily and quickly.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a top view of the apparatus according to an embodiment of the invention.

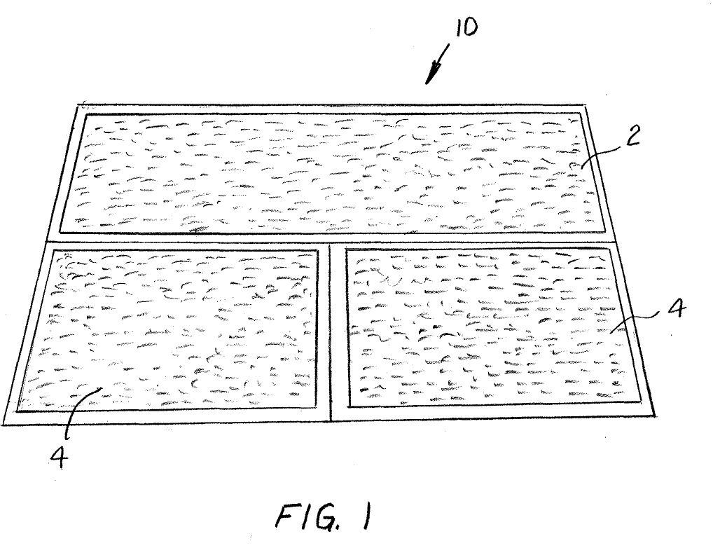

FIG. 2 is a perspective view of the inside of a vehicle with the apparatus blocking the suns rays from both the side window and the windshield.

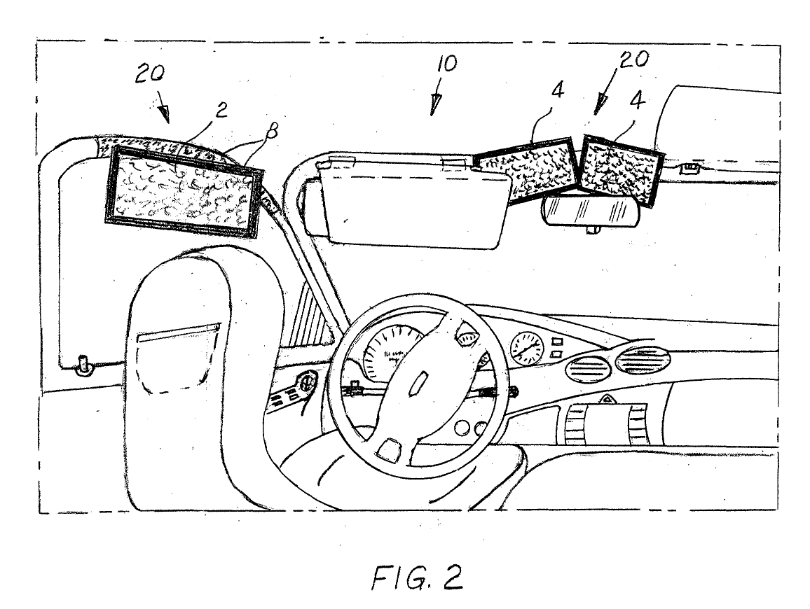

FIG. 3 is a perspective view of the apparatus showing the pieces in a location on the windshield between the vehicle's sun visors.

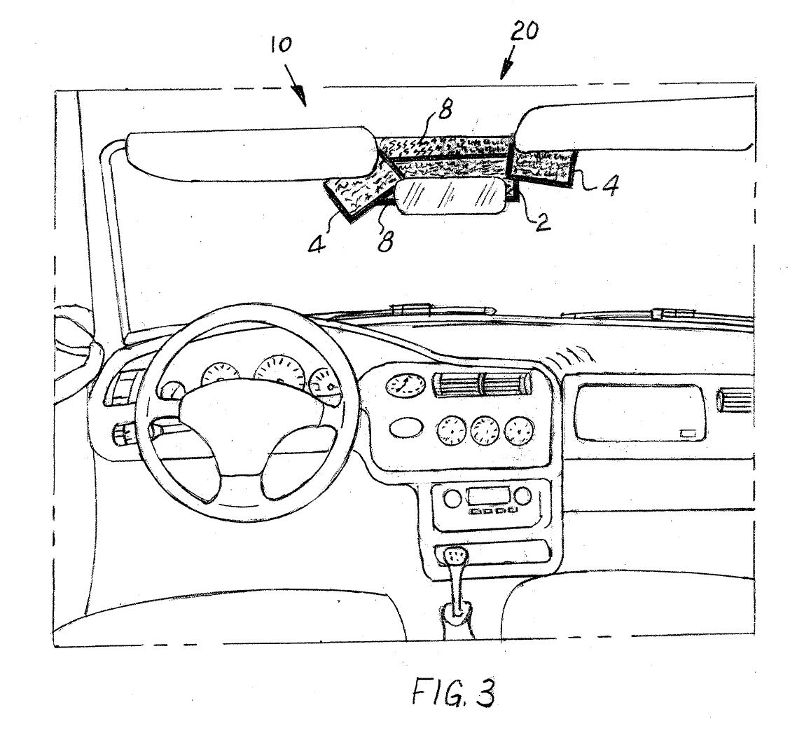

FIG. 4 is a perspective view of the apparatus showing the pieces blocking the sun's rays on a side window.

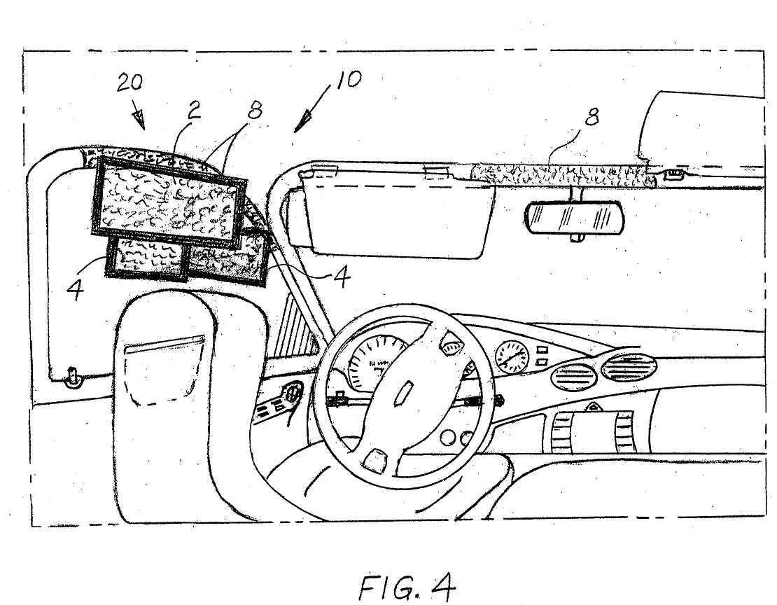

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for enabling a driver to block sun's glare entering virtually any area of a vehicle. The apparatus 10 comprises a first member 2 having a first predetermined size and a first predetermined shape for engagement with a predetermined interior surface adjacent a windshield and a side window of such vehicle for blocking a sun's rays. There is at least one second member 4 having a second predetermined size and a second predetermined shape for engagement with the first member 2. A fastening means, generally designated 20, is engageable with the first member 2 and the at least one second member 4 and such predetermined interior surface adjacent such windshield and such side window of such vehicle for securing the first member 2 and the at least one second member 4 to such interior surface of such vehicle. It is presently preferred that such fastening means 20 includes hook and loop members 8. It is also presently preferred that there are two second members 4.

The predetermined size of the first member is between about 5 inches and about 7 inches in width by between about 17 and about 19 inches in length and it is even more preferred that such first member 2 is 18 inches in length and 6 inches wide. The predetermined size of such at least one second member 4 is between about 5 and about 7 inches in width and between about 8 and about 10 inches in length and even more preferred that such second member is 9 inches in length and 6 inches in width.

Such predetermined interior surface of such vehicle includes the headliner of such vehicle. A first part of the hook and loop fastening system 20 is disposed on such predetermined interior surface of such vehicle and on at least a first surface of the first member 2 and at least one second member 4. A second part of the hook and loop fastener 20 is disposed on a second predetermined surface of the first member 2 and on a second predetermined surface of the at least one second member 4.

In a second aspect there is provided an apparatus 10 for enabling a driver to block sun's glare entering virtually any area of a vehicle. The apparatus 10 comprises a first member 2 having a first predetermined size and a first predetermined shape for engagement with a predetermined interior surface adjacent a windshield of such vehicle for blocking a sun's rays. There are two second members 4, each second member 4 having a second predetermined size and a second predetermined shape for engagement with at least one of the first member 2 and such predetermined interior surface adjacent such windshield of such vehicle for blocking such sun's rays. A fastening means 20 is engageable with the first member 2 and the two second members 4 and such predetermined interior surface adjacent such windshield of such vehicle for securing at least one of the first member 2 to an interior surface of such vehicle adjacent such windshield and for securing at least one of such two second members 4 to one of the first member 2 and to such interior surface of such vehicle. It is presently preferred that such fastening means 20 is a hook and loop 8 fastening means.

In a third aspect the present invention provides an apparatus 10 for enabling a driver to block sun's glare entering virtually any area of a vehicle. The apparatus 10 comprises a first member 2 having a first predetermined size and a first predetermined shape for engagement with a predetermined interior surface adjacent a windshield of such vehicle for blocking a sun's rays. There are two second members 4, each second member 4 having a second predetermined size and a second predetermined shape for engagement with at least one of the first member 2 and such predetermined interior surface adjacent such windshield of such vehicle for blocking such sun's rays. A fastening means 20 is engageable with the first member and such two second members 4 and such predetermined interior surface adjacent such windshield of such vehicle for securing at least one of the first member 2 to an interior surface of such vehicle adjacent such windshield and for securing at least one of the two second members 4 to one of such first member 4 and to such interior surface of such vehicle. It is presently preferred that such fastening means 20 is a hook and loop 8 fastening means.

The sun visor according to the present invention is a specially created visor that can be connected to any of a variety of points inside a vehicle. The apparatus is a multi-piece system that features hook and loop fastening method which allows the driver to position the assembled visor at any location on the headliner of the vehicle. The driver can affix the pieces as desired to block sunlight entering the front or sides of vehicle. The pieces of the visor have to overlap just a little on the edges in order to be connected to each other. It is presently preferred that the number of pieces are three. The apparatus consists of one large piece that is approximately 18 inches long and 6 inches wide. There are two smaller pieces are approximately 9 inches long and about 6 inches wide. The fastening method can be applied in a strategic position along each piece to provide ease of connection. These are lightweight pieces that could be made of a material that is similar to the vehicle's headliner. The color of the pieces can vary and be virtually any color desired.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for enabling a driver to block sun's glare entering virtually any area of a vehicle, said apparatus comprising:
(a) a first member having a first predetermined size and a first predetermined shape for engagement with a predetermined interior surface adjacent one of a windshield and a side window of such vehicle for blocking a sun's rays;
(b) at least one second member having a second predetermined size and a second predetermined shape for engagement with said first member; and
(c) a fastening means engageable with said first member and said at least one second member and such predetermined interior surface adjacent such one of such windshield and such side window of such vehicle for securing at least one of said first member and said at least one second member to such interior surface of such vehicle.

2. The apparatus, according to claim 1, wherein said fastening means includes hook and loop members.

3. The apparatus, according to claim 1, wherein said apparatus includes two second members, a second one of said two second members is engaged with one of said first member and said second one of said second members and such predetermined interior surface adjacent such one of such windshield and such side window of such vehicle for blocking such sun's rays.

4. The apparatus, according to claim 1, wherein said predetermined size of said first member is between about 5 inches and about 7 inches in width by between about 17 and about 19 inches in length.

5. The apparatus, according to claim 1, wherein said predetermined size of said at least one second member is between about 5 and about 7 inches in width and between about 8 and about 10 inches in length.

6. The apparatus, according to claim 1, wherein such predetermined interior surface includes such headliner of such vehicle.

7. The apparatus, according to claim 2, wherein a first part of said hook and loop fastener is disposed on such predetermined interior surface of such vehicle and on at least a first surface of said first member and at least one second member.

8. The apparatus, according to claim 7, wherein a second part of said hook and loop fastener is disposed on a second predetermined surface of said first member and on a second predetermined surface of said at least one second member.

9. An apparatus for enabling a driver to block sun's glare entering virtually any area of a vehicle, said apparatus comprising:
(a) a first member having a first predetermined size and a first predetermined shape for engagement with a predetermined interior surface adjacent one of a windshield and a side window of such vehicle for blocking a sun's rays;
(b) two second members each having a second predetermined size and a second predetermined shape for engagement with said first member, said first member engageable with such predetermined interior surface adjacent such side window of such vehicle for blocking such sun's rays; and
(c) a fastening means engageable with said first member and said two second members and such predetermined interior surface adjacent such side window of such vehicle for securing at least one of said first member and said two second members to such interior surface of such vehicle.

10. The apparatus, according to claim 9, wherein said fastening means includes hook and loop members.

11. The apparatus, according to claim 9, wherein said predetermined size of said first member is between about 5 inches and about 7 inches in width by between about 17 and about 19 inches in length.

12. The apparatus, according to claim 9, wherein said predetermined size of said at least one second member is between about 5 and about 7 inches in width and between about 8 and about 10 inches in length.

13. The apparatus, according to claim 9, wherein such predetermined interior surface includes such headliner of such vehicle.

14. The apparatus, according to claim 10, wherein a first part of said hook and loop fastener is disposed on such predetermined interior surface of such vehicle and on at least a first surface of said first member and at least one second member.

15. The apparatus, according to claim 14, wherein a second part of said hook and loop fastener is disposed on a second predetermined surface of said first member and on a second predetermined surface of said at least one second member.

16. An apparatus for enabling a driver to block sun's glare entering virtually any area of a vehicle, said apparatus comprising:
(a) a first member having a first predetermined size and a first predetermined shape for engagement with a predetermined interior surface adjacent a windshield of such vehicle for blocking a sun's rays;
(b) two second members, each second member having a second predetermined size and a second predetermined shape for engagement with at least one of said first member and such predetermined interior surface adjacent such windshield of such vehicle for blocking such sun's rays; and
(c) a fastening means engageable with said first member and said two second members and such predetermined interior surface adjacent such windshield of such vehicle for securing at least one of said first member to an interior surface of such vehicle adjacent such windshield and for securing at least one of said two second members to one of said first member and to such interior surface of such vehicle.

17. The apparatus, according to claim 16, wherein said fastening means includes hook and loop members.

18. The apparatus, according to claim 16, wherein said predetermined size of said first member is between about 5 inches and about 7 inches in width by between about 17 and about 19 inches in length.

19. The apparatus, according to claim 16, wherein said predetermined size of said at least one second member is between about 5 and about 7 inches in width and between about 8 and about 10 inches in length.

20. The apparatus, according to claim 16, wherein such predetermined interior surface includes such headliner of such vehicle.
